(19) United States
(12) Patent Application Publication
(10) Pub. No.: US 2009/0315372 A1
(43) Pub. Date: Dec. 24, 2009

(54) VEHICLE SEAT INCLUDING AN ENERGY ABSORPTION DEVICE

(75) Inventor: Michael L. Tracht, Ingolstadt (DE)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 12/473,661

(22) Filed: May 28, 2009

(30) Foreign Application Priority Data
Jun. 23, 2008 (DE) 10 2008 029 617.1

(51) Int. Cl. B60N 2/42; B60N 2/48

(52) U.S. Cl. 297/216.12

(57) ABSTRACT

A vehicle seat assembly having a seat body and a headrest subassembly connected to the seat body. The headrest subassembly has a front surface, a backstop member and a first cushion adjacent the backstop member. The first cushion is positioned between the front surface and the backstop member. The first cushion is configured to collapse against the backstop member in response to a force applied by a human head to the headrest subassembly during a vehicle collision. The first cushion remains collapsed while the head is disposed adjacent the headrest subassembly subsequent to the collision.

### CROSS-REFERENCE TO RELATED APPLICATIONS

This application claims foreign priority benefits under 35 U.S.C. §119(a)-(d) to DE 10 2008 029 617.1, filed Jun. 23, 2008, which is hereby incorporated by reference in its entirety.

### BACKGROUND OF THE INVENTION

1. Field of the Invention

Embodiments of the invention disclosed herein relate to the field of energy absorbing devices for use in a headrest of a vehicle seat assembly.

2. Background Art

An energy absorption device for use with a headrest of a vehicle seat assembly is disclosed herein. Examples of headrest assemblies are disclosed in U.S. Pat. No. 6,604,788 and U.S. Patent Application Publication Nos. 2007/0090669 and 2007/0035163.

### SUMMARY OF THE INVENTION

A vehicle seat assembly employing an energy absorption device is disclosed herein. In a first embodiment, the vehicle seat assembly comprises a seat body that is configured for attachment to a vehicle and a headrest subassembly that is connected to the seat body. The headrest subassembly has a front surface, a backstop member and a first cushion that is disposed adjacent the backstop member. The first cushion is positioned between the front surface and the backstop member. In this first embodiment, the first cushion is configured to collapse against the backstop member in response to a force applied by a human head to the headrest subassembly during a vehicle collision. The first cushion remains collapsed while the human head is disposed adjacent the headrest subassembly subsequent to the collision.

In an implementation of the first embodiment, the first cushion is further configured to return to a pre-collapse condition over a predetermined period of time after the human head moves to a position that is spaced apart from the headrest.

In another implementation of the first embodiment, the vehicle seat assembly further comprises a second cushion that is disposed adjacent the first cushion. The second cushion is configured to collapse against the backstop in response to a force that is applied by a human head to the headrest subassembly during a vehicle collision. The second cushion remains collapsed while the human head is disposed adjacent the headrest subassembly subsequent to the collision. In a variation of this implementation, the cushions are disposed adjacent one another such that the first cushion and the second cushion are substantially coaxial with one another. In a further variation, the first cushion is more resilient to collapse than the second cushion. In another variation, the first cushion may have a thickness that differs substantially from a thickness of the second cushion.

In a second embodiment, the vehicle seat assembly comprises a seat body that is configured for attachment to a vehicle and a headrest subassembly that is connected to the seat body. The headrest subassembly has a front surface, a backstop member and a first cushion comprising memory foam disposed adjacent the backstop member. The first cushion is positioned between the front surface and the backstop member. In this second embodiment, the first cushion is configured to collapse against the backstop member in response to a force applied by a human head to the headrest subassembly during a vehicle collision. The first cushion remains collapsed while the human head is disposed adjacent the headrest subassembly subsequent to the collision.

In an implementation of the second embodiment, the first cushion is further configured to return to a pre-collapse condition over a predetermined period of time after the human head moves to a position that is spaced apart from the headrest. In another implementation of the second embodiment, the vehicle seat assembly further comprises a second cushion comprising memory foam that is disposed adjacent the first cushion. The second cushion is configured to collapse against the backstop in response to a force applied by a human head to the headrest subassembly during a vehicle collision. The second cushion remains collapsed while the human head is disposed adjacent the headrest subassembly subsequent to the collision. In a variation of this implementation, the cushions are disposed adjacent one another such that the first cushion and the second cushion are substantially coaxial with one another. In a further variation, the first cushion may be more resilient to collapse than the second cushion. In another variation, the first cushion may have a thickness that differs substantially from a thickness of the second cushion.

In a third embodiment, a vehicle seat assembly comprises a seat body that is configured for attachment to a vehicle and a headrest subassembly that is connected to the seat body. The headrest subassembly has a front surface, a backstop member, and a first cushion subassembly comprising a foam material that is substantially surrounded by a membrane. The first cushion subassembly is disposed adjacent the backstop member. The first cushion subassembly is positioned between the front surface and the backstop member. In this third embodiment, the first cushion subassembly is configured to collapse against the backstop member in response to a force applied by a human head to the headrest subassembly during a vehicle collision such that a quantity of air is ejected from the first cushion subassembly and wherein the membrane at least partially obstructs air from entering the first cushion subassembly. Configured in this manner, the first cushion subassembly remains collapsed while the human head is disposed adjacent the headrest subassembly subsequent to the collision.

In an implementation of the third embodiment, the first cushion subassembly further comprises a valve that is attached to the membrane. The valve is configured to permit air to flow out of the first cushion subassembly and to obstruct air from entering the first cushion subassembly. In a variation of this implementation, the vehicle seat assembly further comprises a plurality of the valves attached to the membrane.

In another implementation of the third embodiment, the membrane comprises nylon.

In another implementation of the third embodiment, the material comprises polyurethane.

In another implementation of the third embodiment, the material comprises memory foam.

In another implementation of the third embodiment, the first cushion subassembly is configured to return to a pre-collapse condition over a pre-determined period of time after the human head moves to a position that is spaced apart from the headrest.

In another implementation of the third embodiment, the material comprises polyurethane and memory foam.

### BRIEF DESCRIPTION OF THE DRAWINGS

The description herein makes reference to the accompanying drawings wherein like reference numerals refer to like parts throughout the several views, and in which:

FIG. 1 is a perspective view illustrating a vehicle equipped with an embodiment of a vehicle seat assembly made in accordance with the teachings of the present invention;

FIG. 2 is a perspective view illustrating an embodiment of a headrest subassembly made in accordance with the teachings of the present invention;

FIG. 3 is a perspective view illustrating the effects of an impact of a human head against the headrest subassembly of FIG. 2;

FIG. 4 is a perspective view illustrating the headrest subassembly of FIG. 3 after the human head has moved to a position spaced apart from the headrest subassembly;

FIG. 5 is a perspective view illustrating the residual effects of the impact of the human head on the headrest subassembly of FIG. 4 at a period of time equal to one half of a predetermined time subsequent to the movement of the human head away from the headrest subassembly;

FIG. 6 illustrates the headrest subassembly of FIG. 4 when the period of time equals the predetermined period of time;

FIG. 7 illustrates an alternate embodiment of the headrest subassembly of FIG. 2 having a plurality of cushions;

FIG. 8 is a cross-sectional view illustrating an alternate embodiment of the headrest subassembly of FIG. 2;

FIG. 9 is a cross-sectional view illustrating the headrest subassembly of FIG. 8 during impact by a human head; and

FIG. 10 illustrates the headrest subassembly of FIG. 9 after the human head has been moved to a position spaced apart from the headrest subassembly.

### DETAILED DESCRIPTION OF THE PREFERRED EMBODIMENT(S)

Detailed embodiments of the present invention are disclosed herein; however, it is to be understood that the disclosed embodiments are merely exemplary of the invention that may be embodied in various and alternative forms. The figures are not necessarily drawn to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Vehicle seat assemblies conventionally include headrests having foam padding such as polyurethane in a shape configured to receive the head of a seat occupant and positioned to prevent the occupant's head from hyperextending rearward during a rear end vehicle collision wherein the vehicle is struck from behind by another vehicle. During a rear end collision, a seat occupant's head is thrust rearward into the vehicle seat's headrest which is typically resiliently mounted to the back support portion of a vehicle seat. The energy imparted by the occupant's head to the headrest is absorbed by the headrest's cushion which deforms during the impact and then springs back to its pre-collision position. As the headrest assembly springs back, it may push the seat occupant's head forward.

It may be desirable to avoid such forward movement of a seat occupant's head immediately following a collision. One way to avoid the forward motion or “bounce back” of an occupant's head after a collision is to provide a cushion or cushion assembly that deforms in response to an impact, but which does not immediately return to its pre-impact condition. Alternatively, it may be desirable to employ a cushion or cushion assembly that, while capable of immediately returning to its pre-impact condition, does so with a limited amount of force such that the material or assembly's tendency to return to its pre-impact condition lacks sufficient force to push an occupant's head forward.

Memory foam, also known as viscoelastic foam, is such a material. In the United States, such a foam material is marketed by Bayer MaterialScience LLC under the trade name Softcel™ Memory Foam. Memory foam is capable of deforming inwardly in response to the application of force without springing back immediately after dissipation of the impact force. When the force is discontinued, such as when a weight is lifted off of the memory foam, the deformed portion of the memory foam slowly returns to its initial condition. Such foam typically comprises open or partially open cell structure such that when it is compressed, air that is infused throughout the material exits the material with only minimal obstruction. Also, because the cell structure is open or partially open and air may have to take a circuitous route to “re-inflate” the foam, such foam material is not urged to return to its original shape with the same strength or speed as that of other foams, such as standard polyurethane foam.

Another structure capable of achieving the effects described above include a mesh or foam material such as, but not limited to, polyurethane foam and nylon mesh used as a spacer material surrounded and/or enveloped by a membrane or barrier which controls the rate at which air may flow of air into the cushion. The barrier or membrane forms a cavity whose internal volume is filled with the cushion. The membrane can be configured to permit air to flow easily out of the cavity, but to obstruct air from flowing back into the cavity once it has been ejected such as through the use of valves. In some embodiments, holes or vents may be employed to control the rate of airflow into, and out of, the membrane. Thus, when an occupant's head impacts such a cushion assembly, the cushion will be rapidly compressed, which, in turn, forces the air infused throughout the cushion to leave the cushion and pass through the membrane. When the compressive force applied by the seat occupant's head is removed, the natural tendency of the cushion would be to return to its original pre-impact condition. However, because air is inhibited from rapidly flowing through the membrane into the cushion, the cushion “re-inflates” at a controlled, slower rate than it would if there were no membrane surrounding the cushion. The rate at which the cushion deflates and re-inflates can be controlled by providing the membrane with a greater or lesser number of apertures and by controlling the size of such apertures. In some instances, stitching may be used to sew the membrane closed around the cushion. In such instances, the holes formed during the stitching process may be sufficient in number and size to provide a desirable re-inflation rate. In some embodiments, a series of one-way valves may be provided in the membrane to permit the rapid ejection of air from the cushion assembly during an impact. Alternatively, a sufficient number of apertures or sufficiently sized apertures or a combination thereof may be acceptable to provide the desired ejection rate of air from the cushion assembly during an impact while also controlling the flow of air back into the cushion assembly subsequent to the impact. A better understanding of the various embodiments of the invention disclosed herein may be obtained through following discussion of the various figures accompanying this disclosure.

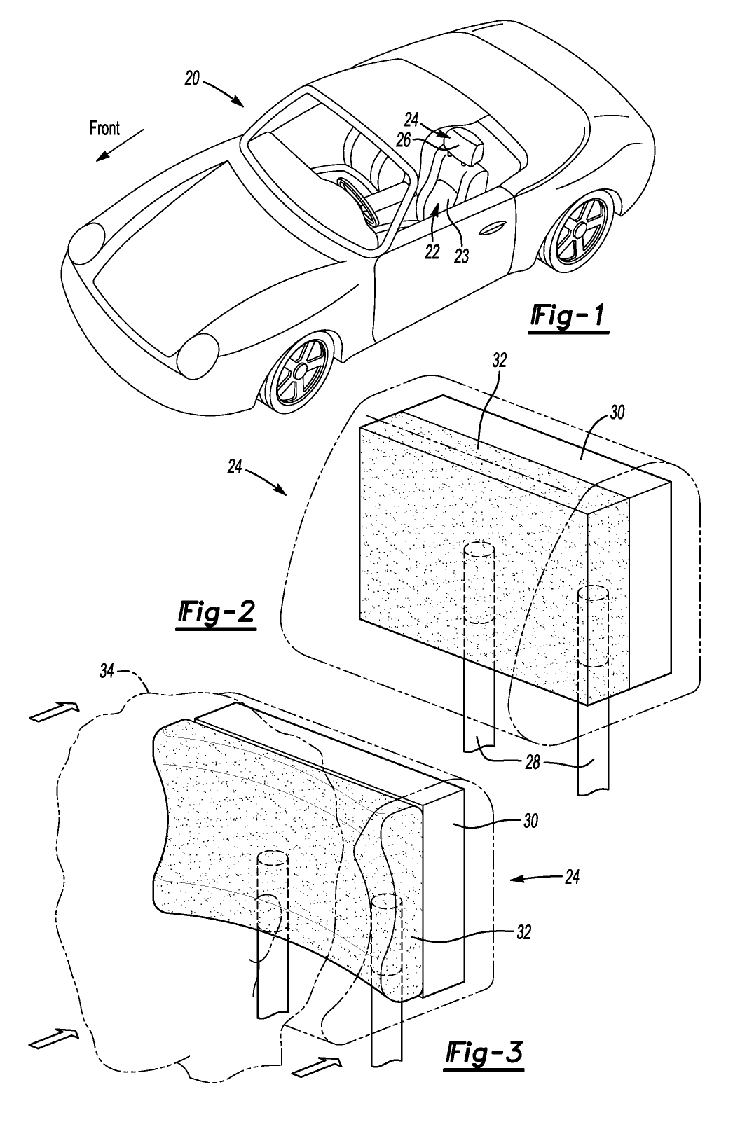

With respect to FIG. 1, a vehicle 20 is depicted in a fragmentary view illustrating a passenger compartment of the vehicle and a vehicle seat assembly 22 mounted therein. Vehicle seat assembly 22 includes a backrest 23 and a headrest subassembly 24 configured in accordance with the principals discussed above. Headrest subassembly 24 includes a front surface 26 facing towards the front of the vehicle. The front of the vehicle is indicated in FIG. 1 with an arrow.

With respect to FIG. 2, a perspective view of headrest subassembly 24 is illustrated. An outer surface of headrest subassembly 24 including front surface 26 is illustrated in phantom lines to permit illustration of the cushion contained therein during an impact. A pair of mounting rods 28 extend upwardly into headrest subassembly 24 and are configured to mate with a pair of apertures disposed on an upper surface of backrest (not shown). Mounting rods 28 further extend upwardly into a backstop member 30. A cushion or first cushion 32 is disposed adjacent to backstop member 30 and is further disposed between front surface 26 and backstop member 30. First cushion 32 is illustrated as a planar, substantially rectangular member. It should be understood by those of ordinary skill in the art that first cushion 32 may take any desirable shape and configuration. Backstop member 30 comprises a rigid material such as wood, metal, plastic, or other suitable rigid material. In other embodiments, other structures may also be employed as backstop 30 such as, but not limited to, cables, wires, mesh material, and a rear surface of headrest subassembly 24. Backstop member 30 serves to support first cushion 32 as an occupant's head impacts headrest subassembly 24. First cushion 32 will deform in the manner described above against backstop member 30 which remains substantially immobile with respect to backrest 23.

In the illustrated embodiment, mounting rods 28 extend upwardly into apertures in backstop member 30. It should be understood by those of ordinary skill in the art that backstop member 30 may be affixed within headrest subassembly 24 in any manner which renders it substantially immobile with respect to backrest 23. In other embodiments, backstop member 30 need not be substantially immobile with respect to backrest 23, but may be designed to move as an occupant's head impacts headrest subassembly 24. In still other embodiments, the headrest subassembly 24 may be adjustable with respect to backrest 23. Backstop member 30 may be made up of two or more parts which can move with respect to one another. In some embodiments, foam may be disposed between the two parts.

In the illustrated embodiment, first cushion 32 is planar and substantially rectangular in configuration. First cushion 32 comprises memory foam and, by virtue of its cell construction, is configured to deform in response to an impact without forcefully or immediately springing back to its pre-deformation configuration. In the illustrated embodiment, first cushion 32 and backstop member 30 comprise only a small portion of headrest subassembly 24. First cushion 32 and backstop member 30 may be surrounded by a shroud of cell foam such as polyurethane which may be formed to take any desirable shape such as that indicated by the phantom lines in FIG. 2. In other embodiments, first cushion 32 and backstop member 30 may not be enveloped in a shroud of closed cell foam. Rather, first cushion 32 may be formed to take any desirable shape such as that indicated by the phantom lines in FIG. 2.

With respect to FIG. 3, headrest subassembly 24 is illustrated as a vehicle occupant's head 34 (shown in phantom lines) impacts headrest subassembly 24 during a rear end collision. First cushion 32 collapses against backstop member 30 and a front portion of cushion 32 caves inwardly and deforms to accommodate a back portion of head 34. Headrest subassembly 24 and backstop member 30 do not significantly deform rearwardly during the illustrated collision.

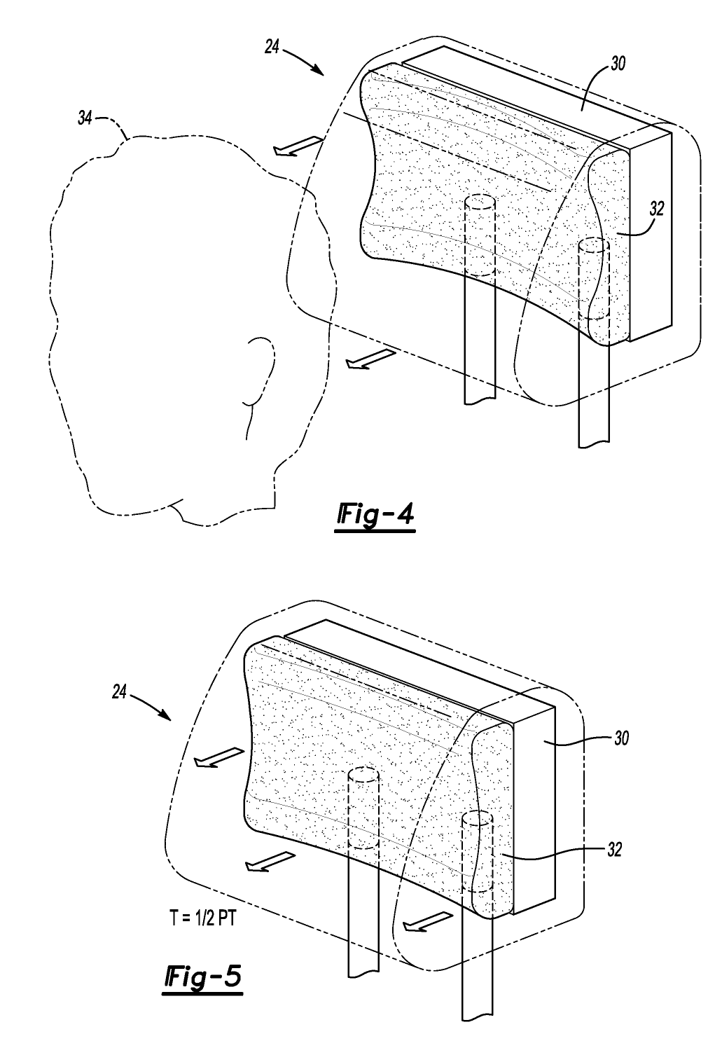

With respect to FIG. 4, headrest subassembly 24 is illustrated subsequent to the collision as occupant head 34 moves away from headrest subassembly 24 (such as when the occupant leans forward or exits the vehicle). The polyurethane or other closed cell foam surrounding first cushion 32 immediately returns to its pre-deformation shape, while first cushion 32 initially retains its deformed shape and does not immediately spring back to its pre-deformation state. The material used in first cushion 32 may be selected based upon the rate at which it springs back or returns to a pre-deformation condition. Any predetermined time to restoration may be specified and an appropriate material may be manufactured to meet such a specification.

With respect to FIG. 5, headrest subassembly 24 is illustrated when time equals one half the predetermined time. In FIG. 5, first cushion 32 is illustrated as it returns to its pre-deformation condition as indicated by the pair of arrows pointing in a forward direction.

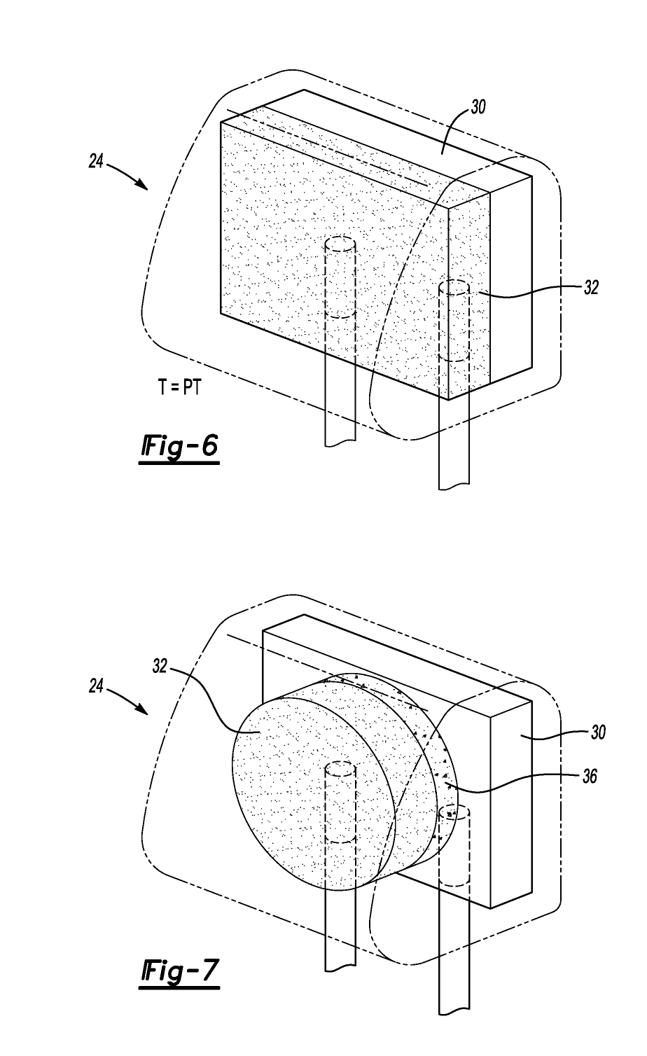

With respect to FIG. 6, headrest subassembly 24 is illustrated when time equals the predetermined time. In this view, first cushion 32 has returned to its pre-deformation condition.

With respect to FIG. 7, an alternate embodiment of headrest subassembly 24 is illustrated in perspective view. In this embodiment, headrest subassembly 24 includes a first cushion 32 and a second cushion 36 disposed between first cushion 32 and backstop member 30. In this embodiment, first and second cushions 32, 36 are each planar members having a generally circular configuration. It should be understood that the teachings of the present invention are compatible with components of all geometric shapes and thicknesses. Second cushion 36 and first cushion 32 are adjacent one another and coaxially aligned. First cushion 32 is illustrated as having a greater thickness than second cushion 36. Second cushion 36 comprises an open or partially open celled memory foam material having the capacity to deform in response to an impact and further to slowly retake its pre-deformation shape.

First cushion 32 and second cushion 36 may have any desirable thickness and may have differing amounts of resilience to deformation. Such an arrangement may permit a more controlled dissipation of impact forces acting on head 34 during a collision. For instance, first cushion 32, which is thicker and disposed forward of second cushion 36, may be less resistant to deformation than second cushion 36. Because first cushion 32 has a greater thickness than second cushion 36, the period of time over which the first cushion 32 will deform may exceed the amount of time in which second cushion 36 will deform. Furthermore, because second cushion 36 has a greater resilience to deformation than first cushion 32, first cushion 32 may completely deform or collapse before second cushion 32 begins to deform or collapse. In this manner, an occupant's head 34 can be exposed to increasing levels of resistance as it moves rearward which may afford the occupant greater comfort and/or less jarring during such an impact. While only two cushions (first cushion 32 and second cushion 36) are illustrated, it should be understood that any number of cushions having any permutation of relative thicknesses and resilience to deformation may be employed.

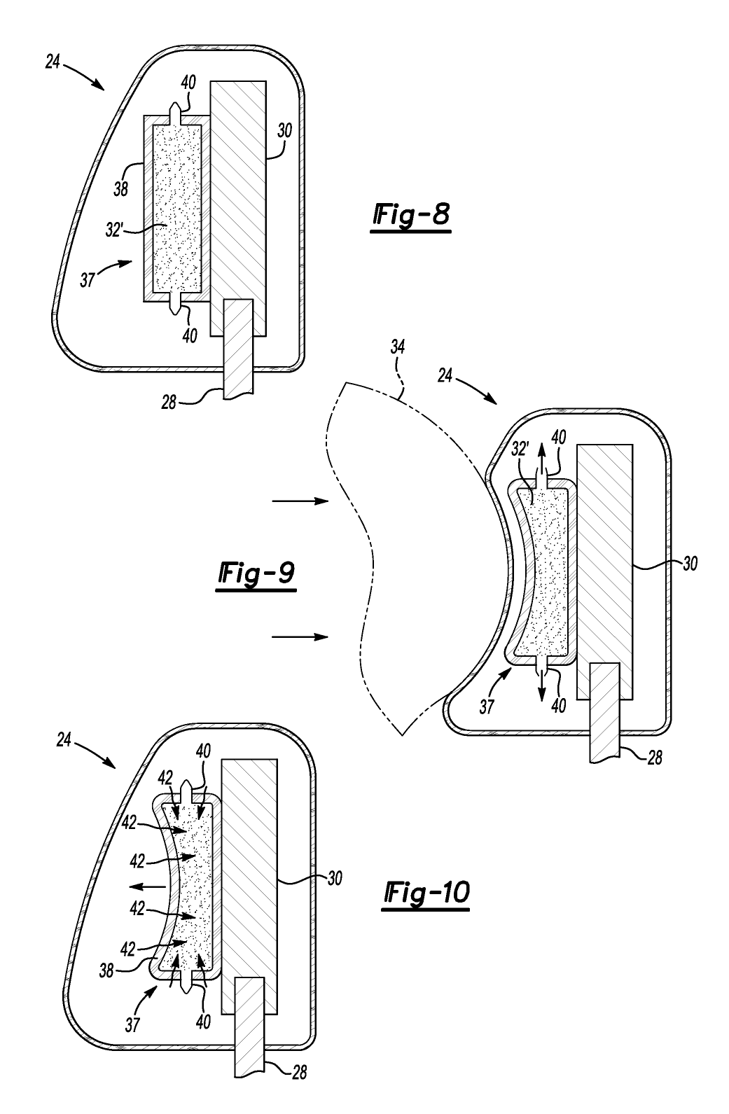

With respect to FIG. 8, another alternate embodiment of headrest subassembly 24 is illustrated. A first cushion subassembly 37 includes first cushion 32′ enclosed within a membrane 38. First cushion 32′ comprises a closed cell foam material such as, but not limited to, polyurethane. Membrane 38 substantially envelopes first cushion 32′. Membrane 38 may be made of materials including nylon, foil, flexible sheet material that is coated or laminated, or any flexible material that controls air permeability. In some embodiments, membrane 38 could be a blow molded material such as materials used for an air bag housing, or any other flexible housing. A pair of valves 40 are embedded in cushion subassembly 37. Valves 40 are open at an end facing first cushion 32′, extend through membrane 38 and protrude into an area outside of first cushion subassembly 37. The portion of valves 40 protruding into the outside area are closed to prevent air from entering first cushion 32′ through valves 40. In other embodiments, rather than having valves, membrane 38 may have vents, holes or other apertures to permit the air to escape from within the membrane to control the rate of air escape.

FIG. 9 illustrates first cushion subassembly 37 as occupant head 34 impacts headrest subassembly 24. In this Figure, the impact of occupant head 34 compresses first cushion subassembly 37 forcing the air infused throughout first cushion 32′ to be ejected through valves 40.

With respect to FIG. 10, occupant head 34 has moved away from headrest subassembly 24. Valves 40 have closed to prevent the flow of air back into first cushion subassembly 37. First cushion subassembly 37 slowly begins to return to its pre-deformation condition as air molecules 42 slowly begin to permeate through membrane 38. In some embodiments, membrane 38 may include one or more holes to permit a slow infusion of air back into first cushion subassembly 37 after an impact.

In some embodiments, headrest subassembly 24 may include both a cushion 32 and a first cushion subassembly 37. In such embodiments, first cushion 32 and first cushion subassembly 37 may be axially aligned with cushion 32 disposed in front of first cushion subassembly 37 in some variations and with first cushion subassembly 37 disposed in front of cushion 32 in other variations. In still other embodiments, a memory foam cushion and a non-memory foam cushion such as polyurethane may be enclosed within a membrane 38.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle seat assembly comprising:
a seat body configured for attachment to a vehicle; and
a headrest subassembly connected to the seat body, the headrest subassembly having a front surface, a backstop member, and a first cushion disposed adjacent the backstop member, the first cushion being positioned between the front surface and the backstop member;
wherein the first cushion is configured to collapse against the backstop member in response to a force applied by a human head to the headrest subassembly during a vehicle collision and wherein the first cushion remains substantially collapsed while the human head is disposed adjacent the headrest subassembly subsequent to the collision.

2. The vehicle seat assembly of claim 1 wherein the first cushion is further configured to return to a pre-collapse condition over a predetermined period of time after the human head moves to a position that is spaced apart from the headrest.

3. The vehicle seat assembly of claim 1 further comprising a second cushion disposed adjacent the first cushion, the second cushion being configured to collapse against the backstop member in response to force applied by a human head to the headrest subassembly during a vehicle collision and wherein the second cushion remains collapsed while the human head is disposed adjacent the headrest subassembly subsequent to the collision.

4. The vehicle seat assembly of claim 3 wherein the cushions are disposed adjacent one another such that the first cushion and the second cushion are substantially coaxial with one another.

5. The vehicle seat assembly of claim 4 wherein the first cushion is more resistant to collapse than the second cushion.

6. The vehicle seat assembly of claim 4 wherein the first cushion has a thickness that differs substantially from a thickness of the second cushion.

7. A vehicle seat assembly comprising:
a seat body configured for attachment to a vehicle; and
a headrest subassembly connected to the seat body, the headrest subassembly having a front surface, a backstop member, and a first cushion comprising memory foam disposed adjacent the backstop member, the first cushion being positioned between the front surface and the backstop member;
wherein the first cushion is configured to collapse against the backstop member in response to a force applied by a human head to the headrest subassembly during a vehicle collision and wherein the first cushion remains substantially collapsed while the human head is disposed adjacent the headrest subassembly subsequent to the collision.

8. The vehicle seat assembly of claim 7 wherein the first cushion is further configured to return to a pre-collapse condition over a predetermined period of time after the human head moves to a position that is spaced apart from the headrest.

9. The vehicle seat assembly of claim 7 further comprising a second cushion comprising memory foam disposed adjacent the first cushion, the second cushion being configured to collapse against the backstop member in response to a force applied by a human head to the headrest subassembly during a vehicle collision and wherein the second cushion remains collapsed while the human head is disposed adjacent the headrest subassembly subsequent to the collision.

10. The vehicle seat assembly of claim 9 wherein the cushions are disposed adjacent one another such that the first cushion and the second cushion are substantially coaxial with one another.

11. The vehicle seat assembly of claim 10 wherein the first cushion is more resistant to collapse than the second cushion.

12. The vehicle seat assembly of claim 10 wherein the first cushion has a thickness that differs substantially from a thickness of the second cushion.

13. A vehicle seat assembly comprising:
a seat body configured for attachment to a vehicle; and
a headrest subassembly connected to the seat body, the headrest subassembly having a front surface, a backstop member, a first cushion subassembly comprising a foam material substantially surrounded by a membrane, the first cushion subassembly being disposed adjacent the backstop member, the first cushion subassembly being positioned between the front surface and the backstop member;
wherein the first cushion subassembly is configured to collapse against the backstop member in response to a force applied by a human head to the headrest subassembly during a vehicle collision such that a quantity of air is ejected from the first cushion subassembly and wherein the membrane at least partially obstructs air from entering the first cushion subassembly whereby the first cushion subassembly remains substantially collapsed while the human head is disposed adjacent the headrest subassembly subsequent to the collision.

14. The vehicle seat assembly of claim 13 wherein the first cushion subassembly further comprises a valve attached to the membrane, the valve being configured to permit air to flow out of the first cushion subassembly and to obstruct air from entering the first cushion subassembly.

15. The vehicle seat assembly of claim 14 further comprising a plurality of the valves attached to the membrane.

16. The vehicle seat assembly of claim 13 wherein the membrane comprises nylon.

17. The vehicle seat assembly of claim 13 wherein the material comprises polyurethane.

18. The vehicle seat assembly of claim 13 wherein the material comprises memory foam.

19. The vehicle seat assembly of claim 13 wherein the first cushion subassembly is configured to return to a pre-collapse condition over a predetermined period of time after the human head moves to a position that is spaced apart from the headrest.

20. The vehicle seat assembly of claim 13 wherein the material comprises polyurethane and memory foam.
